(19) United States
(12) Patent Application Publication
(10) Pub. No.: US 2020/0240513 A1
(43) Pub. Date: Jul. 30, 2020

(54) SHIFT DEVICE

(71) Applicant: KABUSHIKI KAISHA TOKAI-RIKA-DENKI-SEISAKUSHO, Aichi (JP)

(72) Inventors: Keisuke KAMEYAMA, Aichi (JP); Kenji NAKANISHI, Aichi (JP)

(21) Appl. No.: 16/488,051

(22) PCT Filed: Feb. 16, 2018
(86) PCT No.: PCT/JP2018/005590

§ 371 Date: Aug. 22, 2019

(30) Foreign Application Priority Data
Mar. 6, 2017 (JP) 2017-042211

(51) Int. Cl. F16H 59/08; F16H 61/18

(52) U.S. Cl. CPC F16H 59/08; F16H 2059/0295; F16H 61/18

(57) ABSTRACT

In a shift device, a link is rotated as a result of a knob being slidingly operated. Here, the knob is coincidingly disposed on an axial direction of rotation side of the link. For this reason, the dimension of the shift device in the radial direction of rotation of the link can be reduced, and so the shift device can be downsized.

### TECHNICAL FIELD

The present invention relates to a shift device where the shift position of a shift body is changed as a result of the shift body being slidingly operated.

### RELATED ART

Japanese National Publication No. 2013-525201 discloses an activation device where a latching gearwheel is rotated as a result of an activation knob being moved in a translatory fashion.

### SUMMARY OF INVENTION

### Technical Problem

However, in Japanese National Publication No. 2013-525201, the activation knob is disposed on the outer side in the radial direction of rotation of the latching gearwheel.

The present invention has been made in view of the above circumstances, and it is an object thereof to provide a shift device that can be downsized in the radial direction of rotation of a rotating body.

### Solution to Problem

A shift device of a first aspect of the invention includes: a shift body whose shift position is changed as a result of the shift body being slidingly operated; and a rotating body that is rotated as a result of the shift body being slidingly operated, with the shift body being disposed on an axial direction of rotation side of the rotating body.

A shift device of a second aspect of the invention is the shift device of the first aspect, further including a detected member that is provided in the rotating body and with which the shift position of the shift body is detected as a result of the detected member being detected.

A shift device of a third aspect of the invention is the shift device of the first or second aspect, further including a detecting member that is disposed in the rotating body on the opposite side of the shift body and detects the rotational position of the rotating body, whereby the shift position of the shift body is detected.

A shift device of a fourth aspect of the invention is the shift device of any one of the first to third aspects, further including a biasing component that biases the rotating body in the radial direction of rotation of the rotating body, whereby the shift body is biased.

A shift device of a fifth aspect of the invention is the shift device of any one of the first to fourth aspects, further including a support body that supports the shift body and a guide portion that is provided in the support body and guides the sliding of the shift body.

A shift device of a sixth aspect of the invention is the shift device of any of the first to fifth aspects, further including a support body that supports the shift body, a regulating body that is provided in the shift body, and a regulating member that is provided in the support body and regulates the sliding of the regulating body, whereby the sliding operation of the shift body to a predetermined shift position is regulated.

### Advantageous Effects of Invention

In the shift device of the first aspect of the invention, the shift position of the shift body is changed as a result of the shift body being slidingly operated. Furthermore, the rotating body is rotated as a result of the shift body being slidingly operated.

Here, the shift body is disposed on an axial direction of rotation side of the rotating body. For this reason, the shift device can be downsized in the radial direction of rotation of the rotating body.

In the shift device of the second aspect of the invention, the shift position of the shift body is detected as a result of the detected member of the rotating body being detected. For this reason, the shift position of the shift body can be detected.

In the shift device of the third aspect of the invention, the detecting member detects the rotational position of the rotating body, whereby the shift position of the shift body is detected. Here, the detecting member is disposed in the rotating body on the opposite side of the shift body. For this reason, the shift device can be downsized in the radial direction of rotation of the rotating body.

In the shift device of the fourth aspect of the invention, the biasing component biases the rotating body, whereby the shift body is biased. Here, the biasing component biases the rotating body in the radial direction of rotation of the rotating body. For this reason, the shift device can be downsized in the axial direction of rotation of the rotating body.

In the shift device of the fifth aspect of the invention, the support body supports the shift body, and the guide portion guides the sliding of the shift body. Here, the guide portion is provided in the support body. For this reason, the number of parts can be reduced.

In the shift device of the sixth aspect of the invention, the support body supports the shift body. Furthermore, the regulating body is provided in the shift body, and the regulating member regulates the sliding of the regulating body, whereby the sliding operation of the shift body to the predetermined shift position is regulated. Here, the regulating member is provided in the support body. For this reason, the number of parts can be reduced.

### BRIEF DESCRIPTION OF DRAWINGS

FIG. 1 is an exploded perspective view of a shift device pertaining to an embodiment.

FIG. 2 is a sectional view, along line 2-2 of FIG. 1, showing main portions of the shift device.

FIG. 3 is a perspective view showing a base frame of a knob.

FIG. 4A is a sectional view, along line 4-4 of FIG. 1, showing main portions of the shift device and shows a state in which the shift device is in an “H” position.

FIG. 4B is a sectional view, along line 4-4 of FIG. 1, showing main portions of the shift device and shows a state in which the shift device is in an “R” position.

FIG. 5 is a bottom view showing main portions of the shift device.

### DESCRIPTION OF EMBODIMENT

An embodiment of the invention will be described in detail below with reference to the drawings.

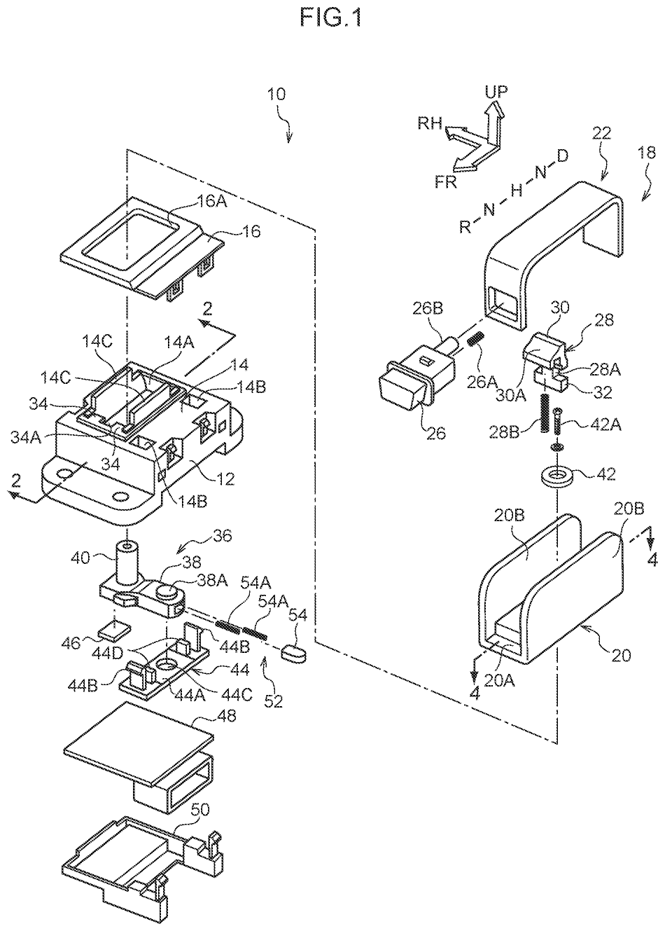

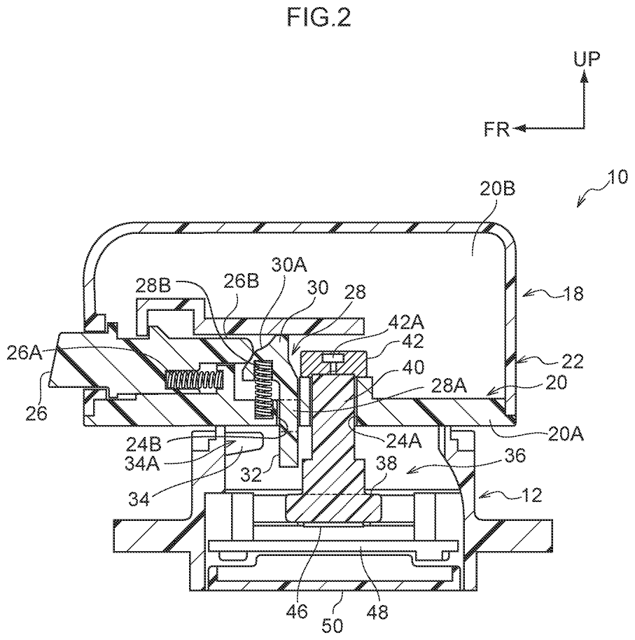

In FIG. 1 a shift device 10 pertaining to the embodiment is shown in an exploded perspective view seen obliquely from the front and left, and in FIG. 2 main portions of the shift device 10 are shown in a sectional view seen from the left. It will be noted that in FIG. 2 the shift device 10 shown in FIG. 1 is shown in a sectional view seen from the left in an assembled state. Furthermore, in the drawings, arrow FR indicates the forward direction of the shift device 10, arrow RH indicates the rightward direction of the shift device 10, and arrow UP indicates the upward direction of the shift device 10.

The shift device 10 pertaining to the present embodiment is configured to be a straight and shift-by-wire shift device. Furthermore, the shift device 10 is configured to be a floor-mounted shift device and is installed on a cabin floor (a vehicle body side) on the vehicle width direction inner side of a driver's seat of a vehicle (automobile), and the front, right, and top of the shift device 10 respectively face the forward direction, the rightward direction, and the upward direction of the vehicle.

As shown in FIG. 1, the shift device 10 is provided with a substantially cuboidal box-shaped plate 12 made of resin that serves as a support body, and the plate 12 is secured to the floor of the cabin. A substantially rectangular pass-through hole 14A is formed through a right-side part of an upper wall 14 of the plate 12, and the longitudinal direction of the pass-through hole 14A is aligned with the front-rear direction. Furthermore, the upper wall 14 of the plate 12 is provided with a pair of rectangular engagement holes 14B on the left side of the pass-through hole 14A, and the engagement holes 14B are formed through the front portion and the rear portion of the upper wall 14. Moreover, the area around the pass-through hole 14A projects in the shape of a rectangular frame from the upper wall 14 of the plate 12, and substantially rectangular guide plates 14C (projections) serving as guide portions are provided in the upper wall 14 of the plate 12. The guide plates 14C stand erect from the projecting portion around the pass-through hole 14A on the right side and the left side of the pass-through hole 14A, and each of the guide plates 14C extends in the front-rear direction.

A rectangular substantially plate-shaped plate cover 16 serving as a cover member is provided above the upper wall 14 of the plate 12, and the upper surface of the plate cover 16 is configured to be a design surface. The plate cover 16 is attached to the plate 12 and covers the upper wall 14. A substantially rectangular through hole 16A is formed in the plate cover 16, and the pass-through hole 14A of the plate 12 and the projecting portion around the pass-through hole 14A are exposed through the through hole 16A and the guide plates 14A project upward through the through hole 16A.

A substantially cuboidal box-shaped knob 18 serving as a shift body is provided above the plate 12, and the knob 18 has its longitudinal direction aligned with the front-rear direction and is disposed on the plate 12. In the shift device 10, the plate cover 16 and the knob 18 are exposed to the cabin interior and the knob 18 is configured to be grippable by an occupant (driver) seated in the driver's seat of the vehicle.

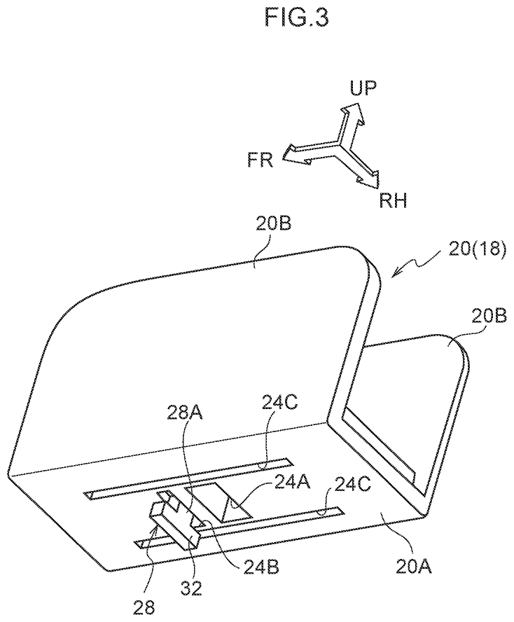

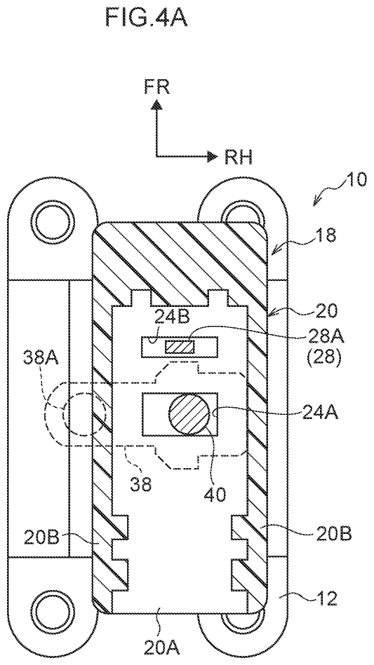

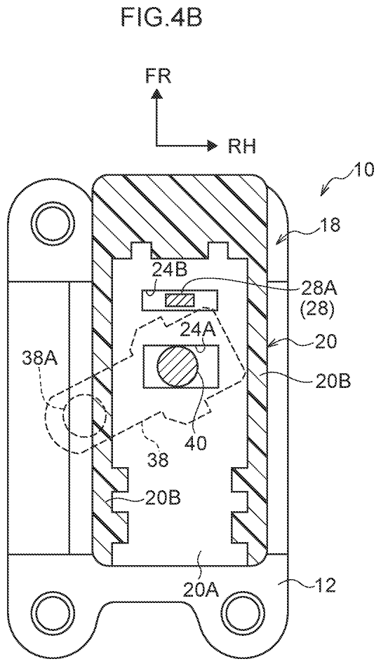

The knob 18 is equipped with a base frame 20 and a knob cover 22. In FIG. 3 the base frame 20 of the knob 18 is shown in a perspective view seen obliquely from the left and rear. Furthermore, in FIG. 4A and FIG. 4B main portions of the knob 18 are shown in sectional views seen from above. It will be noted that in FIG. 4A and FIG. 4B the shift device 10 shown in FIG. 1 is shown in sectional views seen from above in an assembled state. Furthermore, in FIG. 4A and FIG. 4B, the outer shape of a link 38 described below is indicated by dashed lines.

As shown in FIG. 1 to FIG. 3, the base frame 20 is equipped with a rectangular substantially plate-shaped bottom plate 20A, and a pair of side plates 20B stand erect on the right and left sides of the bottom plate 20A. The front portion and the rear portion of the knob cover 22 extend downward, and the knob cover 22 is disposed between the side plates 20B and is attached to the base frame 20 to thereby cover the front side, the upper side, and the rear side of the space between the pair of side plates 20B.

As shown in FIG. 3, FIG. 4A, and FIG. 4B, a substantially rectangular (long hole) through hole 24A is formed in the front-rear direction and right-left direction middle portion of the bottom plate 20A of the base frame 20, and a rectangular through hole 24B is formed on the front side of the through hole 24A. A lever portion 40 described below is inserted into the through hole 24A. The through hole 24A is configured to have an aperture width by which relative movement of the lever portion 40 in the front-rear direction is regulated, and the through hole 24A is open in such a way that the lever portion 40 is movable therein in the right-left direction. Furthermore, the through hole 24B is configured to be a long hole that is shorter in the front-rear direction than in the right-left direction. Moreover, as shown in FIG. 3, guide grooves 24C (groove portions) serving as guided portions are provided in the bottom plate 20A of the base frame 20, and the guide grooves 24C have their longitudinal direction aligned with the front-rear direction on the right side and the left side of the through holes 24A, 24B and open to the lower surface of the bottom plate 20A.

The guide plates 14C of the knob 18 are inserted into the guide grooves 24C of the base frame 20, whereby the knob 18 is disposed on the plate 12. Upper ends of the guide plates 14C are in abutment with groove bottoms (upper surfaces) of the guide grooves 24C, and the guide plates 14C are configured to be movable in the longitudinal direction of the guide grooves 24 (the front-rear direction). For this reason, the through hole 16A of the plate cover 16 is covered by the knob 18, and the through holes 24A, 24B of the knob 18 oppose the pass-through hole 14A of the plate 12. Furthermore, the knob 18 is supported on the plate 12 by the guide plates 14C, relative movement of the knob 18 in the right-left direction is regulated, and the knob 18 is configured to be slidable in the front-rear direction along the upper surface of the plate cover 16. Because of this, the knob 18 is configured to be disposable in shift positions of an “R” position (reverse position), an “N” position (neutral position), an “H” position (home position), an “N” position (neutral position), and a “D” position (drive position) heading from the front side to the rear side. It will be noted that FIG. 4A shows a state in which the knob 18 is disposed in the “H” position and FIG. 4B shows a state in which the knob 18 is disposed in the “R” position.

As shown in FIG. 1, a substantially rectangular prism-shaped button 26 serving as a release portion is assembled to the knob 18, and the button 26 is disposed on the front portion of the knob 18. The button 26 is passed through the knob cover 22, is exposed to the front side of the knob cover 22, and is configured to be movable in a predetermined range in the front-rear direction with respect to the knob cover 22 (the knob 18). Furthermore, a knob spring (coil spring) 26A serving as a release biasing component bridges the base frame 20 (the bottom plate 20A) and the button 26, and the knob spring 26A is compressed and biases the button 26 forward. The button 26 is configured to be pressingly operable, by the occupant, rearward counter to the biasing force of the knob spring 26A. The button 26 is provided with a substantially solid cylinder-shaped release rod 26B, and the release rod 26B projects rearward from the button 26, has a projecting distal end formed in a substantially hemispherical shape, and is integrally formed on the button 26.

A substantially rod-shaped detent rod 28 serving as a regulating body is provided on the rear side of the button 26, and the longitudinal direction of the detent rod 28 is aligned with the up-down direction. The up-down direction (longitudinal direction) middle portion of the detent rod 28 is configured to be a slender portion 28A formed in a substantially rod-like shape, with a substantially block-shaped head portion 30 being integrally formed on the upper portion of the slender portion 28A and with a substantially plate-shaped foot portion 32 being integrally formed on the lower portion. The longitudinal direction of the head portion 30 is aligned with the right-left direction, and an inclined surface 30A is formed in the head portion 30. The inclined surface 30A is inclined so as to project forward heading from its upper side to its lower side on the front side of the head portion 30. Furthermore, the foot portion 32 extends in the right-left direction on the lower side of the slender portion 28A.

The detent rod 28 is inserted into the through hole 24B of the bottom plate 20A, and its movement in the front-rear and right-left directions with respect to the through hole 24B is regulated (see FIG. 4A and FIG. 4B); the detent rod 28 is disposed in the pass-through hole 14A of the plate 12 and is configured to be movable in the front-rear direction together with the knob 18 inside the pass-through hole 14A. Furthermore, the inclined surface 30A of the head portion 30 of the detent rod 28 opposes the distal end of the release rod 26B of the button 26. A detent spring (coil spring) 28B serving as a regulation biasing component bridges the space between the head portion 30 and the bottom plate 20A, and the detent spring 28B is compressed and biases the detent rod 28 upward. Furthermore, the detent rod 28 is configured to be displaceable downward counter to the biasing force of the detent spring 28B and is retained in the knob 18.

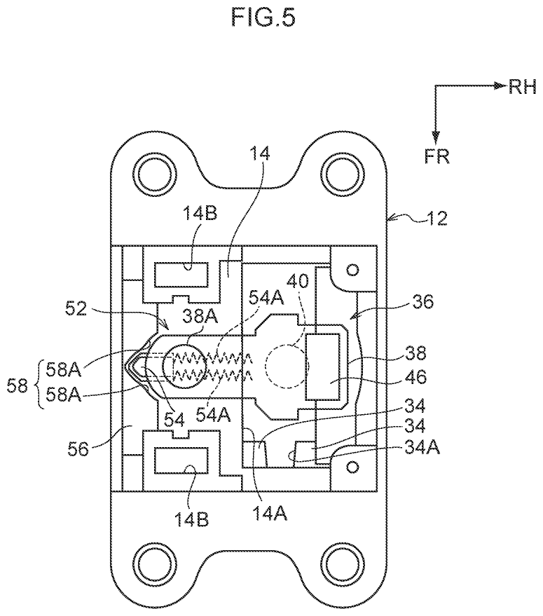

As shown in FIG. 1 and FIG. 5, rectangular plate-shaped regulating plates 34 serving as regulating members are provided on the front side of the pass-through hole 14A of the plate 12. The regulating plates 34 are provided as a pair on both right and left sides on the front side of the pass-through hole 14A and project rearward from the peripheral edge of the pass-through hole 14A and in directions in which they become closer to each other (inward in the right-left direction), and a narrow portion 34A, into which the slender portion 28A of the detent rod 28 is insertable, is formed between the pair of regulating plates 34.

In a state in which the button 26 is not being pressingly operated, the foot portion 32 of the detent rod 28 opposes the rear-side end faces of the regulating plates 34, and forward movement of the detent rod 28 is regulated and sliding of the knob 18 from the front-side “N” position to the “R” position is regulated as a result of the foot portion 32 coming into abutment with the regulating plates 34 (the rear-side end faces). Furthermore, when the button 26 is pressingly operated rearward, the release rod 26B presses the inclined surface 30A of the head portion 30. For this reason, the detent rod 28 becomes displaced downward counter to the biasing force of the detent spring 28B so that the foot portion 32 is moved below the regulating plates 34 and the slender portion 28A of the detent rod 28 opposes the narrow portion 34A. Because of this, the regulation of the movement of the detent rod 28 by the regulating plates 34 is released and the knob 18 becomes slidable forward so that the knob 18 can be disposed from the front-side “N” position to the “R” position.

As shown in FIG. 1, the plate 12 is provided with a detection mechanism 36 serving as a detection component. In FIG. 5 main portions inside the plate 12 are shown in a bottom view.

As shown in FIG. 1 and FIG. 5, the detection mechanism 36 is provided with a long substantially block-shaped link 38 serving as a rotating body, and the link 38 is disposed inside the plate 12 (under the upper wall 14). On one longitudinal direction end portion (the right-side end portion) of the link 38, a substantially open cylinder-shaped lever portion 40 serving as an anchor portion is projectingly formed, and the lever portion 40 is inserted into the pass-through hole 14A and the through hole 16A and is inserted into the through hole 24A of the knob 18.

As shown in FIG. 1 and FIG. 2, an annular fastener 42 serving as an anchor member is provided on the upper end of the lever portion 40, and the outer diameter of the fastener 42 is configured to be larger than the front-rear direction aperture width (aperture dimension) of the through hole 24A of the knob 18. Inside the knob 18, a screw 42A is inserted into a circular hole in the axial center of the fastener 42, and the screw 42A is screwed into the upper end of the lever portion 40 so that the fastener 42 is attached to the lever portion 40. For this reason, the lever portion 40 is prevented from becoming detached from, and is anchored to, the knob 18 by the fastener 42, is configured to be movable in the front-rear direction integrally with the knob 18, and is configured to be movable (relatively movable) in the right-left direction with respect to the knob 18 inside the through hole 24A.

On the other longitudinal direction end portion (the left-side end portion) of the link 38, a pair of substantially solid cylinder-shaped shaft portions 38A are provided, and the shaft portions 38A are configured to be coaxial with each other and project upward and downward as a pair. Furthermore, as shown in FIG. 1, a bracket 44 serving as a retaining portion opposes the shaft portions 38A of the link 38. A pair of engagement claws 44B are formed on both longitudinal direction ends of a substantially strip plate-shaped base portion 44A of the bracket 44, and the engagement claws 44B extend upward. Furthermore, in the base portion 44A of the bracket 44, a circular shaft hole 44C is formed through the longitudinal direction middle portion thereof and prismatic positioning protrusions 44D project therefrom between the shaft hole 44C and each of the engagement claws 44B.

The longitudinal direction of the bracket 44 is aligned with the front-rear direction, and the engagement claws 44B are inserted into and engage with the engagement holes 14B. Furthermore, the positioning protrusions 44D are configured so that the upper wall 14 of the plate 12 is sandwiched between them in a state in which they have been inserted into holes not shown in the drawings formed in the reverse surface of the upper wall 14 of the plate 12, and thus the bracket 44 is attached to the plate 12.

As for the link 38, the shaft portion 38A on the lower side thereof is inserted into the shaft hole 44C of the bracket 44, and the shaft portion 38A on the upper side thereof is inserted into a shaft hole not shown in the drawings formed in the lower surface of the upper wall 14. For this reason, the link 38 is configured to be rotatable about the shaft portions 38A as an axis and is supported by the plate 12 and the bracket 44 in a state in which the axial direction of the shaft portions 38A is aligned with the up-down direction orthogonal to the top surface (upper surface) of the upper wall 14. Because of this, as shown in FIG. 4A and FIG. 4B, when the knob 18 is slid in the front-rear direction, the lever portion 40 is rotated (moved) in the front-rear direction inside the pass-through hole 14A (see FIG. 1 and FIG. 5) while being moved in the right-left direction (the longitudinal direction of the through hole 24A) inside the through hole 24A of the knob 18. Furthermore, when the lever portion 40 is rotated in the front-rear direction inside the pass-through hole 14A of the plate 12, the link 38 is rotated in the front-rear direction about the shaft portions 38A as an axis.

As shown in FIG. 1 and FIG. 5, the detection mechanism 36 is provided with a rectangular plate-shaped magnet 46 serving as a detected member of the detection component, and the magnet 46 is secured by insert molding to the link 38 on the lower side of the lever portion 40 and the outer side in the radial direction of rotation of the link 38. Furthermore, a substantially rectangular plate-shaped sensor base plate 48 serving as a detecting member of the detection component is provided inside the plate 12, and the sensor base plate 48 is configured to be parallel to the upper surface of the upper wall 14, opposes the magnet 46, and is secured to the lower side of the plate 12. Furthermore, a rectangular substantially thin box-shaped sensor cover 50 serving as a cover member is provided on the lower side of the plate 12, and the underside part of the plate 12 (the sensor base plate 48) is covered by the sensor cover 50.

The sensor base plate 48 detects the magnetic force produced by the magnet 46 to thereby detect the rotational position of the magnet 46. Because of this, the rotational position of the link 38 in the front-rear direction is detected and the shift positions of the knob 18 (the “R” position, the “N” position, the “H” position, the “N” position, and the “D” position) are detected.

As shown in FIG. 1 and FIG. 5, a detent mechanism 52 serving as a biasing component is provided between the plate 12 and the link 38.

The detent mechanism 52 is provided with a substantially rectangular prism-shaped detent pin 54 serving as an abutting member, and the detent pin 54 is coaxially inserted (fitted) into an insertion hole in the link 38 from the other longitudinal direction end portion (the left-side end portion) of the link 38. The detent pin 54 projects leftward from the link 38, and the distal end face of the detent pin 54 is curved in a substantially convex shape (hemispherical shape).

Detent springs 54A (in the present embodiment, two) serving as a biasing component bridge the detent pin 54 and a bottom surface (right-side surface) of the insertion hole in the link 38. The two detent springs 54A are disposed one in front of the other in the insertion hole in the link 38, and the detent springs 54A are compressed and bias the detent pin 54 leftward.

The detent mechanism 52 is provided with a substantially cuboid-shaped slope plate 56 serving as an abutted member, and the slope plate 56 has its longitudinal direction aligned with the front-rear direction and is secured (integrally molded) to the left end portion of the inside of the plate 12. A detent slope 58 serving as an acting portion is formed in the right-side end face of the slope plate 56, and the distal end face of the detent pin 54 biased by the detent springs 54A is in abutment with the detent slope 58.

The detent slope 58 is provided with a pair, one in front of the other, of detent surfaces 58A serving as inclined surfaces, and the front-side and rear-side detent surfaces 58A are inclined in a direction heading leftward as they head respectively rearward and forward. In the “H” position of the link 38, the distal end face of the detent pin 54 is in abutment with the front-rear direction center of the detent slope 58 (between the detent surfaces 58A) because of the biasing force of the detent springs 54A.

When the knob 18 is slidingly operated in the front-rear direction from the “H” position, the link 38 is rotated in the front-rear direction, whereby the distal end face of the detent pin 54 is moved rightward (rightward and forward or rightward and rearward) on the detent surfaces 58A counter to the biasing force of the detent springs 54A. Furthermore, when the action of the operating force on the knob 18 has been released in a state in which the knob 18 has been slidingly operated in the front-rear direction from the “H” position, the distal end face of the detent pin 54 is moved leftward on the detent surfaces 58A by the biasing force of the detent springs 54A and the link 38 is rotated in the front-rear direction, whereby the knob 18 is slid (returned) to the “H” position.

A protruding portion is formed in the direction of inclination center portion of each of the detent surfaces 58A, and the protruding portions are curved in convex shapes in the direction of inclination of the detent surfaces 58A. Because of this, when the knob 18 is rotated from the “H” to the “R” position and the “D” position, the distal end face of the detent pin 54 is moved over the detent surfaces 58A while riding over the protruding portions.

Next, the action of the present embodiment will be described.

In the shift device 10 of the above configuration, the shift position of the knob 18 is changed as a result of the knob 18 being slidingly operated in the front-rear direction on the plate 12. When the knob 18 is slidingly operated and the link 38 and the magnet 46 are rotated about the shaft portions 38A, the detection mechanism 36 detects the rotational position of the link 38, whereby the shift position of the knob 18 is detected.

Furthermore, the distal end face of the detent pin 54 provided in the link 38 is in abutment with the detent surfaces 58A of the detent slope 58 because of the biasing force of the detent springs 54A, and when the knob 18 is slidingly operated in the front-rear direction from the “H” position, the link 38 is rotated counter to the biasing force of the detent springs 54A and an operating load acts on the knob 18.

Here, the knob 18 is coincidingly disposed on an axial direction of rotation side of the link 38. For this reason, the dimension of the shift device 10 in the radial direction of rotation of the link 38 (the right-left direction) can be reduced, and so the shift device 10 can be downsized.

Furthermore, the guide plates 14C of the plate 12 are inserted into the guide grooves 24C of the knob 18, and the knob 18 is slidably supported on the plate 12 without having a rotational axis. For this reason, the moving range (stroke) of the knob 18 in the front-rear direction is determined by the guide plates 14C of the plate 12 and the guide grooves 24C of the knob 18, and the guide plates 14C and the guide grooves 24C receive impact loads (overstrokes) that exceed the moving range of the knob 18 and impact loads that try to move the knob 18 in the right-left direction. Furthermore, because the guide plates 14C are integrally provided on the plate 12, the number of parts can be reduced and space for disposing parts can be kept down, so the shift device 10 can be downsized. Moreover, the knob 18 is placed from above on the plate 12, and the guide plates 14C can be inserted into the guide grooves 24C, so assemblability can be improved.

Moreover, the knob 18 is supported on the plate 12, so operating loads from the upper direction or the right-left direction to the knob 18 can be inhibited from being input to the link 38 and the strength of the link 38 can be lowered. Moreover, in contrast to a case where the guide plates 14C are provided on the knob 18 and the guide grooves 24C are provided in the plate 12, liquid (e.g., water) can be inhibited from entering the inside of the plate 12 because the plate 12 is not provided with the guide grooves 14C and is provided with the guide plates 14C, and liquid can be inhibited from reaching the detection mechanism 36 (particularly the sensor base plate 48) inside the plate 12.

Furthermore, when the button 26 of the knob 18 is not being pressingly operated in a case where one has tried to slidingly operate the knob 18 from the front-side “N” position to the “R” position, the foot portion 32 of the detent rod 28 of the knob 18 abuts against the regulating plates 34 of the plate 12, whereby movement to the “R” position is regulated. Here, the detent rod 28 is supported by the knob 18 (is not supported by the link 38). Because of this, the operating load of the knob 18 can be inhibited from being input to the link 38, so the strength of the link 38 can be lowered. Moreover, the regulating plates 34 are provided on the plate 12, so the number of parts can be reduced and the configuration can be simplified.

Furthermore, the link 38 is rotated around an up-down direction axis about the shaft portions 38A following the sliding of the knob 18, so the rotational space of the link 38 in the up-down direction can be narrowed. Because of this, the up-down direction dimension of the plate 12 for rotatably disposing the link 38 can be kept down, so the shift device 10 can be downsized.

Moreover, the distal end face of the detent pin 54 is in abutment with the detent surfaces 58A of the detent slope 58 because of the biasing force of the detent springs 54A so that the knob 18 is disposed in the “H” position, and the detent pin 54 and the magnet 46 are provided in the link 38. For this reason, the precision of the rotational position of the magnet 46 with respect to the shift position of the knob 18 can be enhanced, and the shift position of the knob 18 can be detected with high precision by detecting with the sensor base plate 48 the rotational position of the magnet 46. Moreover, the magnet 46 is provided more on the outer side in the radial direction of rotation of the link 38 than the lever portion 40. For this reason, when the knob 18 is moved in the front-rear direction, the magnet 46 is rotated about the shaft portions 38A of the link 38 as an axis, so the moving amount of the magnet 46 can be amplified with respect to the moving amount of the knob 18, and the shift position of the knob 18 can be detected with even higher precision.

Furthermore, the magnet 46 is moved substantially parallel to the upper wall 14 of the plate 12, so the sensor base plate 48 can be disposed substantially parallel to the upper wall 14. For this reason, compared to a case where the sensor base plate 48 is disposed inclined with respect to the horizontal direction (with respect to the upper wall 14 of the plate 12), space in the up-down direction for providing the sensor base plate 48 can be narrowed, so the height dimension of the plate 12 can be kept down and the shift device 10 can be downsized. Moreover, compared to a case where the sensor base plate 48 is disposed vertically (substantially parallel to the up-down direction) on the lever portion 40 side of the link 38, the area in which the sensor base plate 48 is disposed can be enlarged.

Furthermore, in the detent mechanism 52, the detent pin 54 is biased outward in the radial direction of rotation of the link 38 by the biasing force of the detent springs 54A, and the distal end face of the detent pin 54 is in abutment with the detent slope 58. For this reason, the space occupied by the detent mechanism 52 in the up-down direction can be narrowed, so the dimension of the plate 12 in the up-down direction can be kept down and the shift device 10 can be downsized.

It will be noted that although in the present embodiment the guide plates 14C are provided on both the right and left sides of the pass-through hole 14A in the plate 12, there may also be a guide plate 14C on just one of the right and left sides of the pass-through hole 14A. Furthermore, the guide plates 14C serving as projections are provided on the plate 12 and the guide grooves 24C serving as groove portions are formed in the bottom plate 20A of the knob 18, but the groove portions may also be formed in the plate 12 and the projections may also be formed on the knob 18.

Moreover, in the present embodiment, the knob 18 is slidingly operated in the front-rear direction. However, it suffices for the knob 18 to be slidingly operated along the design surface (which may also be spherical) (substantially parallel to the design surface) without having an axis of rotation.

Furthermore, in the present embodiment, the button 26 serving as a release portion is exposed to the front side of the knob 18 and is configured to be pressingly operable rearward. However, the release portion may also be exposed to a side plate 20B of the knob 18 and configured to be pressingly operable in the right-left direction.

Moreover, in the present embodiment, the shift device 10 disposed on the floor of the vehicle was described as an example. However, the shift device may also be disposed on an instrument panel or a steering column.

The disclosure of Japanese Patent Application No. 2017-042211, filed on Mar. 6, 2017, is incorporated in its entirety by reference herein.

1. A shift device comprising:
a shift body whose shift position is changed as a result of the shift body being slidingly operated; and
a rotating body that is rotated as a result of the shift body being slidingly operated, with the shift body being disposed on an axial direction side of the rotating body.

2. The shift device according to claim 1, further comprising a detected member that is provided in the rotating body and with which the shift position of the shift body is detected as a result of the detected member being detected.

3. The shift device according to claim 1, further comprising a detecting member that is disposed in the rotating body on an opposite side of the shift body and detects the rotational position of the rotating body, whereby the shift position of the shift body is detected.

4. The shift device according to claim 1, further comprising a biasing component that biases the rotating body in the radial direction of rotation of the rotating body, whereby the shift body is biased.

5. The shift device according to claim 1, further comprising:
a support body that supports the shift body; and
a guide portion that is provided in the support body and guides the sliding of the shift body.

6. The shift device according to claim 1, further comprising:
a support body that supports the shift body;
a regulating body that is provided in the shift body; and
a regulating member that is provided in the support body and regulates the sliding of the regulating body, whereby sliding operation of the shift body to a predetermined shift position is regulated.
